(19) United States
(12) Patent Application Publication
(10) Pub. No.: US 2023/0177588 A1
(43) Pub. Date: Jun. 8, 2023

(54) SYSTEM AND METHOD FOR PROVIDING ONE OR MORE RECOMMENDATIONS

(71) Applicant: FLIPKART INTERNET PRIVATE LIMITED, Bengaluru (IN)

(72) Inventors: Mayank Kant, Bangalore (IN); Jatin Dixit, Shivpuri (IN); Anupam, Bangalore (IN); Ravi Vijaya Raghavan, Bangalore (IN)

(73) Assignee: FLIPKART INTERNET PRIVATE LIMITED, Bengaluru (IN)

(21) Appl. No.: 18/074,430

(22) Filed: Dec. 2, 2022

(30) Foreign Application Priority Data
Dec. 3, 2021 (IN) 202141056190

(51) Int. Cl. G06Q 30/0601

(52) U.S. Cl. CPC G06Q 30/0631

(57) ABSTRACT

A system and method for providing one or more recommendations. The method encompasses identifying, target feature(s) from a set of features influencing a customer feedback data associated with customer(s) of a digital platform. The method thereafter comprises fine-tuning, a sub-system based on the target feature(s). Further the method encompasses determining, a probability of a promoter rating for the customer(s) based on the fine-tuned sub-system and the customer feedback data. The method thereafter encompasses determining, a contribution of each target feature in the probability of the promoter rating. The method further comprises generating, at least one of a customer insight and a governance parameter, based on the contribution of each target feature in the probability of the promoter rating. Further the method encompasses providing, the one or more recommendations on the digital platform based on at least one of the customer insight and the governance parameter.

### RELATED APPLICATION

This application claims priority under 35 U.S.C. § 119 to Indian Patent Application No. 202141056190, filed on Dec. 3, 2021, the entire contents of which are incorporated herein by reference

### TECHNICAL FIELD

The present invention generally relates to applied data science and more particularly to systems and methods for providing one or more recommendations.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Over the past few years, digital technologies have enhanced to a great extent and with the enhancement in the digital technologies it is now possible to provide various facilities to users of electronic devices. Digital platforms such as e-commerce platforms provide the users facilities to buy and/or sell various products online. In order to ensure the quality of service and customer satisfaction, a number of surveys are run by these digital platforms. The surveys may include but are not limited to price experience score (PES), selection perception score/selection experience score (SPS/SES) and such other surveys. Also, the users/customers can provide their feedback at least by providing ratings for a product or a service such as from 1 star to 5 stars via these surveys. The ratings provided by the users are further used to calculate a net promoter score (NPS). More specifically, for the ratings given between 1 to 5 stars, the NPS can be calculated as follows:

(Number of 4&5 star ratings−Number of 1&2 star ratings)/Total responses,

where:

4 & 5 star responders are promoters and the 4 & 5 star ratings are promoter ratings, 1 & 2 star responders are detractors and the 1 & 2 star ratings are detractor ratings, and 3 star responders are neutrals and 3 star ratings are neutral ratings.

The NPS measures customer experience and predicts business growth. The currently known solutions fail to use the NPS efficiently and effectively in ensuring the quality of service and the customer satisfaction at least by generating and providing to the users, relevant recommendations. Also, the known solutions of identifying NPS drivers are suboptimal in ways of identifying and measuring a feature impact. These currently known solutions also fail to provide localized explanations for each customer.

Furthermore, currently organizations run customer surveys to generate insights on what is directly asked in the surveys. The currently known solutions fail to analyze customer feedback data and generate recommendations and governance around what is not directly asked in the surveys by identifying underlying relationships hidden in the customer feedback data. Also, the currently known arts fails to provide a solution to identify various parameters/features that differentiate a promoter with a detractor.

Therefore, there are a number of limitations of the current solutions and there is a need in the art to provide a method and system for efficiently and effectively providing one or more recommendations based on an analysis of a customer feedback data.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for providing one or more recommendations on a digital platform based on an analysis of a customer feedback data. Also, an object of the present invention is to generate, based on the customer feedback data, at least one of a customer insight and a contribution of each factor/feature leading to a change in a customer feedback data over a period of time, in order to further provide one or more recommendations. Also, an object of the present invention is to provide a solution to split promoters and detractors based on various business factors for feature design and extensive feature selection for further identifying a probability of a promoter rating. Another object of the present invention is to break down the log-odds of a probability of a promoter rating into contributions from each feature using Shap values. Another object of the present invention is to provide a solution that quantifies a contribution of each factor in week on week/month on month PES/SES movement to help in understanding what leads to PES/SPS movement and to plan interventions accordingly. Yet another object of the present invention is to provide a solution to analyze the customer feedback data and generate recommendations and governance around what is not directly asked in the survey.

Furthermore, in order to achieve the aforementioned objectives, the present invention provides a method and system for providing one or more recommendations.

A first aspect of the present invention relates to the method for providing one or more recommendations. The method encompasses identifying, by an identification unit, a set of features influencing a customer feedback data associated with one or more customers of a digital platform. The method further comprises identifying, by the identification unit, one or more target features from the set of features. The method thereafter comprises fine-tuning, by the processing unit, a sub-system based on the one or more target features. Further the method leads to determining, by the processing unit, a probability of a promoter rating for the one or more customers based on the fine-tuned sub-system and the customer feedback data associated with the one or more customers. The method thereafter encompasses determining, by the processing unit using shap values, a contribution of each target feature from the one or more target features in the probability of the promoter rating. The method further comprises generating, by the processing unit, at least one of a customer insight and a governance parameter, based on the contribution of each target feature in the probability of the promoter rating. Further the method encompasses providing, by the processing unit, the one or more recommendations on the digital platform based on at least one of the customer insights and the governance parameter.

Another aspect of the present invention relates to a system for providing one or more recommendations. The system comprises an identification unit, configured to identify a set of features influencing a customer feedback data associated with one or more customers of a digital platform. The identification unit is further configured to identify one or more target features from the set of features. Further the system comprises a processing unit, configured to fine-tune, a sub-system based on the one or more target features. The processing unit is further configured to determine a probability of a promoter rating for the one or more customers based on the fine-tuned sub-system and the customer feedback data associated with the one or more customers. Further the processing unit is configured to determine, using shap values, a contribution of each target feature from the one or more target features in the probability of the promoter rating. The processing unit is thereafter configured to generate, at least one of a customer insight and a governance parameter, based on the contribution of each target feature in the probability of the promoter rating. Further the processing unit is configured to provide the one or more recommendations on the digital platform based on at least one of the customer insights and the governance parameter.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for providing one or more recommendations, in accordance with exemplary embodiments of the present invention.

FIG. 2 illustrates an exemplary method flow diagram [200], for providing one or more recommendations, in accordance with exemplary embodiments of the present invention.

FIG. 3 illustrates an exemplary graph depicting a change in a NPS along with a contribution of various target features in said change, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from an identification unit, a processing unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution for efficiently and effectively providing one or more recommendations on a digital platform based on an analysis of a customer feedback data received via one or more surveys. In an implementation, the customer feedback data is associated with one or more digital platforms and the digital platform is an e-commerce platform. More particularly, to efficiently and effectively provide the one or more recommendations the present invention encompasses analyzing: interactions of customer(s) with the one or more digital platforms, and the customer feedback data of the customer(s). The customer feedback data may include but not limited to one or more promoter ratings, one or more detractor ratings and one or more bigrams, etc. Also, the analysis of the interactions of the customer(s) with the one or more digital platforms and analysis of the customer feedback data of the customer(s) helps in generating customer insights and/or governance parameters on what is not directly asked in the surveys by identifying underlying relationships hidden in the customer feedback data.

Furthermore, to generate the customer insights and/or governance parameters the present invention encompasses fine-tuning a subsystem based on a set of target features (i.e. a set of most relevant features) identified from a set of features influencing the customer feedback data. In an implementation, the subsystem is a driver model built using the LightGBM model to explain a customer NPS score. More specifically, the fine-tuned subsystem and customer feedback data is used to determine a probability of a promoter rating of the customer(s). The present invention thereafter encompasses using Shap values to understand a contribution of each factor/feature in the determined probability of the promoter rating of the customer(s). Further the present invention encompasses aggregating data indicating the contribution of each factor/feature for multiple customers to generate robust customer insights and governance parameters. This data is also analyzed for multiple time periods to quantify a change from a Pre Period to a Post period. Also, the present invention thereafter encompasses providing the customer(s), the one or more recommendations on the digital platform based on at least one of the customer insights and the governance parameters.

Therefore, the present invention provides a novel solution of providing one or more recommendations on a digital platform based on customer insights and the governance parameters. The present invention also provides a technical advancement over the currently known solutions by ensuring no overfitting based on a model choice, feature selection and hyperparameters tuning. Also, the present invention provides a technical advancement over the currently known solutions by identifying underlying relationships hidden in the customer feedback data to generate customer insights and/or governance parameters on what is not directly asked in the surveys. The present invention also provides a technical advancement over the currently known solutions by providing recommendations on the digital platform based on at least one of the customer insight and the governance parameter, wherein the customer insight and/or the governance parameter are determined based on a contribution of each target feature in a probability of a promoter rating. Also, the present invention provides a technical advancement over the currently known solutions by determining the contribution of each target (important) feature in the probability of the promoter rating to further identify why a customer score associated with a customer feedback data is high or low.

Hereinafter, exemplary embodiments of the present disclosure will be described in detail with reference to the accompanying drawings so that those skilled in the art can easily carry out the present disclosure.

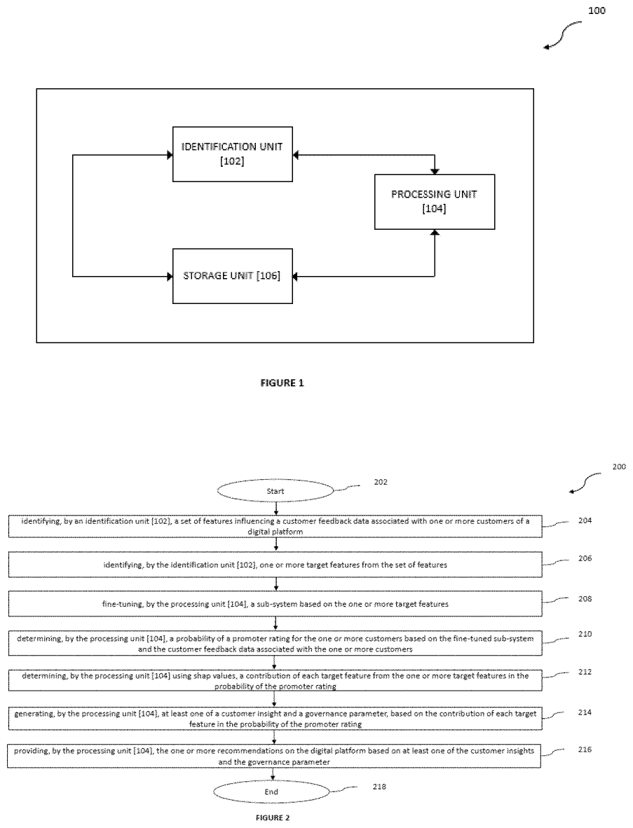

Referring to FIG. 1, an exemplary block diagram of a system [100] for providing one or more recommendations is shown. The system [100] comprises at least one identification unit [102], at least one processing unit [104] and at least one storage unit [106]. Also, all of the components/units of the system [100] are assumed to be connected to each other unless otherwise indicated below. Also, in FIG. 1 only a few units are shown, however, the system may comprise multiple such units or the system [100] may comprise any such numbers of said units, as required to implement the features of the present disclosure. Further, in an implementation, the system [100] may be present in a server device to implement the features of the present invention.

The system [100] is configured to provide one or more recommendations, with the help of the interconnection between the components/units of the system [100].

The identification unit [102] of the system [100] is connected to at least one processing unit and at least one storage unit [106]. The identification unit [102] is configured to identify a set of features influencing a customer feedback data associated with one or more customers of a digital platform. In an implementation, based on various use cases the set of features are identified in one or more time windows. The digital platform is an e-commerce platform and the customer feedback data is a feedback data provided by the one or more customers for the e-commerce platform. More specifically, the customer feedback data comprises data (i.e., the feedback data) provided by the one or more customers for the e-commerce platform during one or more surveys. For instance, the customer feedback data is collected based on the one or more surveys such as Price experience score (PES), Selection Perception/Experience score (SPS/SES) etc. In an implementation the customer feedback data may be associated with one or more e-commerce platforms. Also, the customer feedback data may include but not limited to at least one of a promoter ratings (for instance: 4 & 5 star ratings out of 5 stars are promoter ratings), a detractor ratings (for instance: 1 & 2 star ratings out of 5 stars are detractor ratings), a neutral ratings (for instance: 3 star ratings out of 5 stars are neutral ratings) and bigrams.

Also, the set of features influencing the customer feedback data are identified based on at least one of one or more attributes associated with the customer feedback data, one or more digital platforms associated with the one or more customers and an interaction of the one or more customers with the one or more digital platforms. The one or more attributes associated with the customer feedback data are one or more parameters such as pricing, quality, selection, experience and customer demographics etc. The pricing parameters include but not limited to parameters indicating details such as including but not limited to if the digital platform (i.e. the e-commerce platform) is costly, if the digital platform's prices are better than competition, shipping fee charged by the digital platform, etc. The selection parameters include but not limited to parameters indicating details such as including but not limited to an enough collection of products within a price range, serviceability in a Pin-Code, out of stock items, etc. The quality parameters include but not limited to parameters indicating details such as including but not limited to a confidence on quality, distribution of product quality, fake products, catalog quality, etc. The experience parameters include but not limited to parameters indicating details such as including but not limited to pre-purchase (Impressions, PPV etc.), purchase behavior (units, GMV, orders), post purchase (return/replace/delivery/IMS/On time delivery) etc. The customer demographics parameters include but not limited to parameters indicating details such as including but not limited to location, age, gender, debit card premiumness, credit card premiumness, preferred digital platform, age on the digital platform etc. Further, the one or more digital platforms associated with the one or more customers are one or more e-commerce platforms, wherein each e-commerce platform is an e-commerce platform on which the one or more recommendations are to be provided or a competitor e-commerce platform of the e-commerce platform on which the one or more recommendations are to be provided. Also, the interaction of the one or more customers with the one or more digital platforms comprises the interaction (such an immediate interaction, long-term interaction etc.) of the one or more customers with the e-commerce platform on which the one or more recommendations are to be provided and/or interaction of customers with the competitor e-commerce platform(s) of said e-commerce platform (on which the one or more recommendations are to be provided).

Further, the processing unit [104] of the system [100] is connected to at least one identification unit [102] and at least one storage unit [106]. In an implementation, after identification of the set of features, the processing unit [104] is configured to perform at least one of a data quality check (QC) action and an exploratory data analysis on the set of features. The data quality check (QC) action is performed on the set of features to make sure that correct data (i.e., correct features) is extracted to implement the features of the present invention. For example, in case of some features where missing values (errors) are high for last 1 month, last 3 months data may be used. Also, the exploratory data analysis (EDA) is performed on the set of features to understand relationships between various features of the set of features and a rating provided by the one or more customers during the one or more surveys.

The identification unit [102] is further configured to identify one or more target features from the set of features. The one or more target features are one or more most relevant/important features that are required to implement the features of the present invention. The one or more target features are identified in such a manner that no significant drop should occur in performance. More specifically, the one or more target features are identified from the set of features based on at least one of: dropping of one or more features from the set of features based on mutual information (MI) values, dropping of one or more highly correlated features from the set of features without dropping a validation set area under the curve (AUC), backward stepwise feature removal, and tuning of one or more features of the set of features based on a business relevance and consistency. The dropping of the one or more features from the set of features based on mutual information (MI) values further encompasses dropping of the one or more features from the set of features based on values (i.e. the MI values) indicating how much a feature provides an information of another feature(s) present in the set of features. Therefore, the features with higher MI values (i.e. features with higher information of another feature(s)) are dropped from the set of features for identification of the one or more target features from the set of features. Further dropping of the one or more highly correlated features from the set of features without dropping the validation set area under the curve (AUC) further encompasses dropping of one or more features from one or more highly correlated features present in the set of features such that the validation set area under the curve (AUC) should not be dropped, wherein the validation set area under the curve (AUC) indicates an accuracy level. Also, the backward stepwise feature removal encompasses removal of one or more features from the set of features that are of lesser importance as compared to the other features based on a model accuracy. For instance, in an implementation several iterations are performed till the accuracy does not drop. In each iteration if ‘n’ features are available then ‘n’ models are built on ‘n−1’ features and dropping one feature. Among said n models, a model with highest AUC is selected and the feature dropped corresponding to that model is dropped. Further, tuning of the one or more features of the set of features based on the business relevancy and consistency further encompasses tuning of the one or more features of the set of features to improve the business relevancy and consistency.

Considering an example, say, if a set of features comprising 800 features influencing a customer feedback data associated with one or more customers of a digital platform is identified. In this example, to identify one or more target feature (i.e. one or more important features), the identification unit [102], may for instance, firstly drop 400 features from the 800 features based on mutual information (MI) values, thereafter drop 150 features from remaining 400 features based on identification of highly correlated features, next drop 200 features from remaining 250 features based on backward stepwise feature removal and then lastly drop 25 features from remaining 50 features based on tuning of features to improve a business relevance and consistency. Therefore, in the given example, 25 features may be identified as target features.

The processing unit [104] is configured to fine-tune a sub-system based on the one or more target features. In an implementation the sub-system is a driver model built using the LightGBM model to explain a customer NPS score. In the given implementation, the LightGBM model is used for modeling along with 5-fold CV and early stopping. Also, the LightGBM model is used as it intelligently deals with categorical features and missing values and has high speed & accuracy. Furthermore, in the given implementation hyperparameters tuning is performed using random search where hyperparameters are sampled 1000 times from a given distribution and the hyperparameters that lead to best performance on the Out of time (OOT) validation set are selected. Out of time validation set is based on the responses which are received post the training period to ensure that model holds its performance over time. The sub-system is fine-tuned to determine a probability of a promoter rating for the one or more customers. More specifically, the processing unit [104] is configured to determine the probability of the promoter rating for the one or more customers based on the fine-tuned sub-system and the customer feedback data associated with the one or more customers. In an event, the probability of the promoter rating for one or more customers indicates a probability of the one or more customers to give 4 and/or 5 star rating from a total of 5 stars during one or more surveys.

Further, once the probability of the promoter rating for the one or more customers is determined, the processing unit [104] is configured to determine, using shap values, a contribution of each target feature from the one or more target features in the probability of the promoter rating. More specifically, the processing unit [104] is configured to determine the contribution of each target feature towards log odds of the probability of the promoter rating by determining shap values. In an implementation, the probability of the promoter rating is first converted into a total shap value and then the total shap value is broken down in shap values from each target feature. The shap values from each target feature indicates the contribution of each target feature in the probability of the promoter rating.

Once the contribution of each target feature in the probability of the promoter rating is determined, the processing unit [104] is thereafter configured to generate, at least one of a customer insight and a governance parameter, based on the contribution of each target feature in the probability of the promoter rating. Also, in an implementation the generation of the customer insight is further based on an analysis of the contribution of each target feature from the one or more target features for the probability of the promoter rating and a net promoter score (NPS) associated with the customer feedback data of the one or more customers. More specifically, a linear model is used to model a relationship between the NPS and a shap value from each target feature, such that, the contribution of a target feature towards the NPS=Beta(Shap Value). Also, in an implementation the generation of the customer insight is further based on a feature importance, wherein the feature importance is equal to Mean Absolute Contribution of each target feature. Furthermore, the customer insight is generated at, at least one of one or more customer cohort levels and one or more category levels. For instance, a set of customers may be mapped to certain categories based on their past browsing history, which helps in generating the customer insights at category levels. In an example, a customer cohort may include a set of new customers that are from metro cities and are non-plus members (i.e. are regular members of an e-commerce platform). Also, in the given example the customer cohort may be associated with categories such as personal care, sports fitness and the like. Further, in the given example a customer insight for said customer cohort associated with personal care, sports fitness and the like categories is determined by determining a contribution of one or more target features for a probability of a promoter rating and a net promoter score (NPS) associated with a customer feedback data of the customers of said customer cohort.

Furthermore, the governance parameter includes a contribution of each target feature from the one or more target features in a change in a net promoter score (NPS) associated with the customer feedback data of the one or more customers over a period of time. Also, the generation of the contribution of each target feature in the change in the NPS associated with the customer feedback data of the one or more customers over the period of time is further based on an analysis of: a contribution of each target feature for the probability of the promoter rating at a starting and at an ending of a target time period window, and a net promoter score associated with the customer feedback data of the one or more customers at multiple time periods. More specifically, a linear model is used to model a relationship between the NPS and a total shap value determined based on the probability of the promoter rating at the starting and at the ending of the target time period window. For instance, at time=t1 the relationship between a total shap value and a NPS may be as below:

NPS(t1)˜Beta*(Total Shap t1)+Constant

NPS(t1)˜Beta*(Shap Target Feature1 t1+Shap Target Feature2 t1+ . . . )+Constant

Further, the contribution of each target feature on the NPS can be calculated as:

Change in the NPS due to target feature1=Beta(Shap Target Feature1 t1−Shap Target Feature1 t2).

Once at least one of the customer insights and the governance parameter are generated, the processing unit [104] is configured to provide the one or more recommendations on the digital platform based on at least one of the customer insights and the governance parameter. For example, based on customer insight, it may be identified that a set of new customers look for good discounts and free shipping, whereas a set of premium customers look for complete selection and product availability. Therefore, one or more recommendations are provided to the set of new customer basis good discounts and free shipping, and/or one or more recommendations are provided to the set of premium customer basis complete selection and product availability. Also, in one other example, if between the first 2 weeks of a month and the last 2 weeks of said month, pricing related features such as free shipping and conditional discounts led to an improvement in NPS whereas selection related features like branded share led to a drop in the NPS, one or more recommendations may be provided based on the pricing related features.

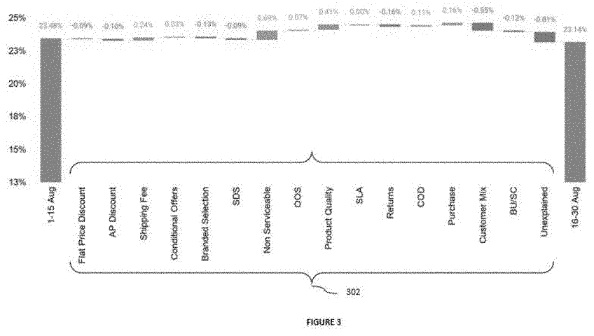

Referring to FIG. 2 an exemplary method flow diagram [200], for providing one or more recommendations, in accordance with exemplary embodiments of the present invention is shown. In an implementation the method is performed by the system [100]. Further, in an implementation, the system [100] may be present in a server device to implement the features of the present invention. Also, as shown in FIG. 2, the method starts at step [202].

At step [204] the method comprises identifying, by an identification unit [102], a set of features influencing a customer feedback data associated with one or more customers of a digital platform. In an implementation based on various use cases the set of features may be identified periodically or in one or more time windows. Also, in another implementation based on various use cases the set of features may be identified continuously. The digital platform is an e-commerce platform and the customer feedback data is a feedback data provided by the one or more customers for the e-commerce platform. More specifically, the customer feedback data comprises data (i.e. the feedback data) provided by the one or more customers for the e-commerce platform during one or more surveys. For instance, the customer feedback data is collected based on one or more surveys such as Price experience score (PES), Selection Perception/Experience score (SPS/SES) etc. In an implementation the customer feedback data may be associated with one or more e-commerce platforms. Also, the customer feedback data may include but not limited to at least one of a promoter ratings (for instance: 9 & 10 star ratings out of 10 stars are promoter ratings), a detractor ratings (for instance: 1 & 2 star ratings out of 10 stars are detractor ratings), a neutral ratings (for instance: 6 & 7 star ratings out of 10 stars are neutral ratings) and bigrams.

Also, the set of features influencing the customer feedback data are identified based on at least one of one or more attributes associated with the customer feedback data, one or more digital platforms associated with the one or more customers and an interaction of the one or more customers with the one or more digital platforms. The one or more attributes associated with the customer feedback data are one or more parameters such as pricing, quality, selection, experience and customer demographics, etc. The pricing parameters include but are not limited to parameters indicating details such as including but not limited to if the digital platform (i.e. the e-commerce platform) is costly, if the digital platform's prices are better than competitor digital platform's prices, shipping fee charged by the digital platform, etc. The selection parameters include but not limited to parameters indicating details such as including but not limited to an enough collection of products within a price range, serviceability in a Pin-Code, out of stock items etc. The quality parameters include but are not limited to parameters indicating details such as including but not limited to a confidence on quality, distribution of product quality, fake products, catalog quality etc. The experience parameters include but are not limited to parameters indicating details such as including but not limited to pre-purchase (Impressions, PPV etc.), purchase behavior (units, GMV, orders), post purchase (return/replace/delivery/IMS/On time delivery) etc. The customer demographics parameters include but are not limited to parameters indicating details such as including but not limited to location, age, gender, debit card premiumness, credit card premiumness, preferred digital platform, age on the digital platform etc. Further, the one or more digital platforms associated with the one or more customers are one or more e-commerce platforms, wherein each e-commerce platform is an e-commerce platform on which the one or more recommendations are to be provided or a competitor e-commerce platform of the e-commerce platform on which the one or more recommendations are to be provided. Also, the interaction of the one or more customers with the one or more digital platforms comprises the interaction of the one or more customers with the e-commerce platform on which the one or more recommendations are to be provided and/or the interaction of customers with the competitor e-commerce platform(s) of said e-commerce platform (on which the one or more recommendations are to be provided).

Also, in an implementation after identifying the set of features, the method further comprises performing, by a processing unit [104], at least one of a data quality check (QC) action and an exploratory data analysis on the set of features. The data quality check (QC) action is performed on the set of features to make sure that correct data (i.e. correct features) is extracted to implement the features of the present invention. For example, in case of some features where an error rate is high for the last 15 days, last 1 month data may be used. Also, the exploratory data analysis (EDA) is performed on the set of features to understand relationships between various features of the set of features and a rating provided by the one or more customers during the one or more surveys.

Next at step [206] the method comprises identifying, by the identification unit [102], one or more target features from the set of features. The one or more target features are one or more most relevant features that are required to implement the features of the present invention. The one or more target features are identified in such a manner that no significant drop should occur in performance. More specifically, the one or more target features are identified from the set of features based on at least one of: dropping of one or more features from the set of features based on mutual information (MI) values, dropping of one or more highly correlated features from the set of features without dropping a validation set area under the curve (AUC), backward stepwise feature removal, and tuning of one or more features of the set of features based on a business relevance and consistency. The dropping of the one or more features from the set of features based on the mutual information (MI) values further encompasses dropping of the one or more features from the set of features based on values indicating how much a feature provides information of other feature(s) present in the set of features. Therefore, the features with higher MI values (i.e. features with higher information of other feature(s)) are dropped from the set of features for identification of the one or more target features from the set of features. Further dropping of the one or more highly correlated features from the set of features without dropping the validation set area under the curve (AUC) further encompasses dropping of one or more features from one or more highly correlated features present in the set of features such that the validation set area under the curve (AUC) should not be dropped, wherein the validation set area under the curve (AUC) indicates an accuracy level. Also, the backward stepwise feature removal encompasses removal of one or more features that are of lesser importance as compared to other features present in the set of features. Further, tuning of the one or more features of the set of features based on the business relevancy and consistency further encompasses tuning of the one or more features of the set of features to improve the business relevancy and consistency. Considering an example if a set of features comprising 1000 features influencing a customer feedback data associated with one or more customers of a digital platform is identified. The method in the given example encompasses identifying by the identification unit [102], one or more target feature (i.e. one or more important features), may be by firstly dropping 500 features from the 1000 features based on mutual information (MI) values, thereafter by dropping 200 features from remaining 500 features based on identification of highly correlated features, next by dropping 250 features from remaining 300 features based on backward stepwise feature removal and then by dropping 25 features from remaining 50 features based on tuning of features to improve a business relevance and consistency. Therefore in the given example 25 features may be identified as target features.

Further, at step [208] the method comprises fine-tuning, by the processing unit [104], a sub-system based on the one or more target features. In an implementation the sub-system is a driver model built using the LightGBM model to explain a customer NPS score. In the given implementation the LightGBM model is used for modeling along with 5-fold cross-validation (CV) and early stopping. Also, the LightGBM model is used as it intelligently deals with categorical features and missing values and has high speed & accuracy. Furthermore, in the given implementation hyper-parameters tuning is performed using random search and out of time (OOT) cross validation set. The method provides a technical advancement over the currently known solutions by ensuring no overfitting based on the model choice, feature selection and hyperparameters tuning. The sub-system is fine-tuned to determine a probability of a promoter rating for the one or more customers. More specifically, the method at step [210] encompasses determining by the processing unit [104], the probability of the promoter rating for the one or more customers based on the fine-tuned sub-system and the customer feedback data associated with the one or more customers. In an event, the probability of the promoter rating for one or more customers indicates a probability of the one or more customers to give 9 and/or 10 star rating from a total of 10 stars during one or more surveys.

Further, once the probability of the promoter rating for the one or more customers is determined, the method at step [212] comprises determining, by the processing unit [104] using shap values, a contribution of each target feature from the one or more target features in the probability of the promoter rating. More specifically, the method encompasses determining by the processing unit [104], the contribution of each target feature towards log odds of the probability of the promoter rating by determining shap values. In an implementation, the probability of the promoter rating is first converted into a total shap value and then the total shap value is broken down in shap values from each target feature. The shap values from each target feature indicates the contribution of each target feature in the probability of the promoter rating.

Once the contribution of each target feature in the probability of the promoter rating is determined, the method at step [214] comprises generating, by the processing unit [104], at least one of a customer insight and a governance parameter, based on the contribution of each target feature in the probability of the promoter rating. The determined contribution of each target feature in the probability of the promoter rating provides a technical advancement over the currently known solutions by providing underlying relationships hidden in the customer feedback data which further help in generating the customer insight(s) and/or governance parameter(s) on what is not directly asked in the surveys. Also, in an implementation the generation of the customer insight is further based on an analysis of the contribution of each target feature from the one or more target features for the probability of the promoter rating and a net promoter score (NPS) associated with the customer feedback data of the one or more customers. More specifically, a linear model is used to model a relationship between the NPS and a shap value from each target feature, such that, the contribution of a target feature towards the NPS=Beta(Shap Value). Also, in an implementation the generation of the customer insight is further based on a feature importance, wherein the feature importance is equal to Mean Absolute Contribution of each target feature. Furthermore, the customer insight is generated at, at least one of one or more customer cohort levels and one or more category levels. For instance, a set of customers may be mapped to certain categories based on one or more common events associated with the set of customers, which help in generating the customer insights at category levels. In an example a customer cohort may include a set of new customers that are from tier 2 cities and are plus members (i.e. premium members of an e-commerce platform). Also, in the given example the customer cohort may be associated with categories such as electronics, lifestyle and the like. Further, in the given example a customer insight for said customer cohort associated with electronics, lifestyle and the like categories is determined by determining a contribution of one or more target features for a probability of a promoter rating and a net promoter score (NPS) associated with a customer feedback data of the customers of said customer cohort.

Furthermore, the governance parameter includes a contribution of each target feature from the one or more target features in a change in a net promoter score (NPS) associated with the customer feedback data of the one or more customers over a period of time. Also, the generation of the contribution of each target feature in the change in the NPS associated with the customer feedback data of the one or more customers over the period of time is further based on an analysis of: a contribution of each target feature for the probability of the promoter rating at a starting and at an ending of a target time period window, and a net promoter score associated with the customer feedback data of the one or more customers at multiple time periods. More specifically, a linear model is used to model a relationship between the NPS and a total shap value determined based on the probability of the promoter rating at the starting and at the ending of the target time period window. For instance, at time=t1 the relationship between a total shap value and a NPS may be as below:

NPS(t1)˜Beta*(Total Shap t1)+Constant

NPS(t1)˜Beta*(Shap Target Featurel t1+Shap Target Feature2 t1+ . . . )+Constant

where, the contribution of each target feature on the NPS can be calculated as:

Change in the NPS due to target featurel=Beta(Shap Target Featurel t1−Shap Target Feature1 t2).

Furthermore, referring to FIG. 3 an exemplary graph depicting a change in a NPS from 1-15 August timeline to 16-30 August timeline along with a contribution of various target features [302] in said change is shown in accordance with exemplary embodiments of the present invention. The graph depicted in FIG. 3 indicates that the NPS of 1-15 August timeline is changed from 23.48% to 23.14% in 16-30 August timeline due to one of a positive (depicted in green) and negative (depicted in red) impact of various target features [302].

Once at least one of the customer insight and the governance parameter are generated, at step

the method comprises providing, by the processing unit [104], the one or more recommendations on the digital platform based on at least one of the customer insight and the governance parameter. For example, based on customer insight, it may be identified that a set of customers look for an availability of a particular set of products in a specific price range. Therefore, one or more recommendations are provided to said set of customers basis availability of said particular set of products in said specific price range. Also, in one other example, if between the first 2 days of a week and the last 2 days of said week, quality related features such as assured quality and conditional returns led to an improvement in NPS, one or more recommendations may be provided based on the quality related features.

After providing the one or more recommendations, the method terminates at step [218].

### Use Cases:

There are a number of use cases of the solution as depicted in the present disclosure. Some of the use cases are provided as below:
It can be easily identified how to improve NPS by optimally investing in resources.
A movement of a business metric and a corresponding NPS change can be easily monitored.
A sudden change in an NPS value can be easily explained and managed.

Thus, the present invention provides a novel solution of providing one or more recommendations on a digital platform. The present invention also provides a technical advancement over the currently known solutions by ensuring no overfitting based on a model choice, feature selection and hyperparameters tuning. Also, the present invention provides a technical advancement over the currently known solutions by identifying underlying relationships hidden in the customer feedback data to generate customer insights and/or governance parameters on what is not directly asked in the surveys. The present invention also provides a technical advancement over the currently known solutions by providing recommendations on the digital platform based on at least one of the customer insight and the governance parameter, wherein the customer insight and/or the governance parameter are determined based on a contribution of each target feature in a probability of a promoter rating. Also, the present invention provides a technical advancement over the currently known solutions by determining the contribution of each target (important) feature in the probability of the promoter rating to further identify why a customer score associated with a customer feedback data is high or low.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method of providing one or more recommendations, the method comprising:
identifying, by an identification unit [102], a set of features influencing a customer feedback data associated with one or more customers of a digital platform;
identifying, by the identification unit [102], one or more target features from the set of features;
fine-tuning, by a processing unit [104], a sub-system based on the one or more target features;
determining, by the processing unit [104], a probability of a promoter rating for the one or more customers based on the fine-tuned sub-system and the customer feedback data associated with the one or more customers;
determining, by the processing unit [104] using shap values, a contribution of each target feature from the one or more target features in the probability of the promoter rating;
generating, by the processing unit [104], at least one of a customer insight and a governance parameter, based on the contribution of each target feature in the probability of the promoter rating; and
providing, by the processing unit [104], the one or more recommendations on the digital platform based on at least one of the customer insights and the governance parameter.

2. The method as claimed in claim 1, wherein the governance parameter includes a contribution of each target feature from the one or more target features in a change in a net promoter score (NPS) associated with the customer feedback data of the one or more customers over a period of time.

3. The method as claimed in claim 2, wherein the generation of the contribution of each target feature in the change in the NPS associated with the customer feedback data of the one or more customers over the period of time is further based on an analysis of:
a contribution of each target feature for the probability of the promoter rating at a starting and at an ending of a target time period window, and
a net promoter score associated with the customer feedback data of the one or more customers at multiple time periods.

4. The method as claimed in claim 1, wherein the generation of the customer insight is further based on an analysis of: the contribution of each target feature from the one or more target features for the probability of the promoter rating, and a net promoter score associated with the customer feedback data of the one or more customers.

5. The method as claimed in claim 4, wherein the customer insight is generated at, at least one of one or more customer cohort levels and one or more category levels.

6. The method as claimed in claim 1, wherein the customer feedback data comprises data provided by the one or more customers during one or more surveys.

7. The method as claimed in claim 1, wherein the set of features are identified based on at least one of one or more attributes associated with the customer feedback data, one or more digital platforms associated with the one or more customers and an interaction of the one or more customers with the one or more digital platforms.

8. The method as claimed in claim 1, wherein the set of features are identified in one or more time windows.

9. The method as claimed in claim 1, further comprises performing, by a processing unit [104] at least one of a data quality check (QC) action and an exploratory data analysis on the set of features, after identifying the set of features.

10. The method as claimed in claim 1, wherein the one or more target features are identified from the set of features based on at least one of:
dropping of one or more features from the set of features based on mutual information (MI) values,
dropping of one or more highly correlated features from the set of features without dropping a validation set area under the curve (AUC),
backward stepwise feature removal, and
tuning of one or more features of the set of features based on a business relevancy and consistency.

11. A system of providing one or more recommendations, the system comprising:
an identification unit [102], configured to identify:
a set of features influencing a customer feedback data associated with one or more customers of a digital platform, and
one or more target features from the set of features; and
a processing unit [104], configured to:
fine-tune, a sub-system based on the one or more target features,
determine, a probability of a promoter rating for the one or more customers based on the fine-tuned sub-system and the customer feedback data associated with the one or more customers,
determine, using shap values, a contribution of each target feature from the one or more target features in the probability of the promoter rating,
generate, at least one of a customer insight and a governance parameter, based on the contribution of each target feature in the probability of the promoter rating, and
provide, the one or more recommendations on the digital platform based on at least one of the customer insight and the governance parameter.

12. The system as claimed in claim 11, wherein the governance parameter includes a contribution of each target feature from the one or more target features in a change in a net promoter score (NPS) associated with the customer feedback data of the one or more customers over a period of time.

13. The system as claimed in claim 12, wherein the generation of the contribution of each target feature in the change in the NPS associated with the customer feedback data of the one or more customers over the period of time is further based on an analysis of:
a contribution of each target feature for the probability of the promoter rating at a starting and at an ending of a target time period window, and
a net promoter score associated with the customer feedback data of the one or more customers at multiple time periods.

14. The system as claimed in claim 11, wherein the generation of the customer insight is further based on an analysis of: the contribution of each target feature from the one or more target features for the probability of the promoter rating, and a net promoter score associated with the customer feedback data of the one or more customers.

15. The system as claimed in claim 14, wherein the customer insight is generated at, at least one of one or more customer cohort levels and one or more category levels.

16. The system as claimed in claim 11, wherein the customer feedback data comprises a data provided by the one or more customers during one or more surveys.

17. The system as claimed in claim 11, wherein the set of features are identified based on at least one of one or more attributes associated with the customer feedback data, one or more digital platforms associated with the one or more customers and an interaction of the one or more customers with the one or more digital platforms.

18. The system as claimed in claim 11, wherein the set of features are identified in one or more time windows.

19. The system as claimed in claim 11, wherein the processing unit [104] is further configured to perform, at least one of a data quality check (QC) action and an exploratory data analysis on the set of features, after identification the set of features.

20. The system as claimed in claim 11, wherein the one or more target features are identified from the set of features based on at least one of:
dropping of one or more features from the set of features based on mutual information (MI) values,
dropping of one or more highly correlated features from the set of features without dropping a validation set area under the curve (AUC),
backward stepwise feature removal, and
tuning of one or more features of the set of features based on a business relevancy and consistency.
